(19) United States
(12) Patent Application Publication
(10) Pub. No.: US 2014/0040219 A1
(43) Pub. Date: Feb. 6, 2014

(54) METHODS AND SYSTEMS FOR A DEADLOCK RESOLUTION ENGINE

(71) Applicants: Hideaki Kimura, Providence, RI (US); Goetz Graefe, Madison, WI (US); Harumi Kuno, Cupertino, CA (US)

(72) Inventors: Hideaki Kimura, Providence, RI (US); Goetz Graefe, Madison, WI (US); Harumi Kuno, Cupertino, CA (US)

(21) Appl. No.: 13/563,625

(22) Filed: Jul. 31, 2012

(51) Int. Cl. G06F 9/52

(52) U.S. Cl. CPC G06F 9/524
USPC 707/704

(57) ABSTRACT

In at least some examples, a system may include a processor core and a non-transitory computer-readable memory in communication with the processor core. The non-transitory computer-readable memory may store a deadlock resolution engine to resolve a deadlock condition based on an abort shortest pipeline policy.

### BACKGROUND

Traditional database systems are driven by the assumption that disk I/O is the primary bottleneck, overshadowing all other costs. However, future database systems may involve many-core processors, large main memory, and low-latency semiconductor mass storage. In the increasingly common case that the working data set fits in memory or low-latency storage, new bottlenecks emerge: locking, latching, logging, and critical sections in the buffer manager. Efforts have been made to address the latching and logging issues. Addressing the locking issue is also needed.

### BRIEF DESCRIPTION OF THE DRAWINGS

For a detailed description of examples of the invention, reference will now be made to the accompanying drawings in which:

FIG. 1 shows a system in accordance with an example of the disclosure;

FIG. 2A shows a multi-core processor in accordance with an example of the disclosure;

FIG. 2B shows a multi-processor node in accordance with an example of the disclosure;

FIG. 3 shows a multi-node system in accordance with an example of the disclosure;

FIG. 4 shows a deadlock resolution engine in accordance with an example of the disclosure;

FIG. 5 shows a method in accordance with an example of the disclosure; and

FIG. 6 shows components of a computer system in accordance with an example of the disclosure.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

The following discussion is directed to methods and systems for handling locking in a database system. The disclosed techniques are intended for modern hardware and address various database locking issues including key range locks and deadlock resolution. These techniques are applicable to various database systems. Experiments with Shore-MT, a transaction processing engine used as the implementation basis, show throughput improvement by factors of 5 to 50.

It should be noted that the examples given herein should not be interpreted, or otherwise used, as limiting the scope of the disclosure, including the claims. In addition, one skilled in the art will understand that the following description has broad application, and the discussion of any particular example is not intended to intimate that the scope of the disclosure, including the claims, is limited to that example.

The disclosed deadlock resolution engine for handling database deadlock resolution issues may be implemented by software executed by hardware, by programmable hardware, and/or by application specific integrated circuits (ASICs). In accordance with disclosed examples, the disclosed deadlock resolution engine operations are intended for modern hardware. In contrast, legacy database systems are intended to balance CPU operations against the bottleneck of disk I/O. However, databases on modern hardware may be based on an architecture dominated by many core processors, large main memory, and low-latency semiconductor mass storage, and thus face different bottlenecks.

Locking is a mechanism to separate concurrent transactions. A suitable locking scheme is shown in Table 1, where share (S) mode is distinguished from exclusive (X) mode (N refers to no-lock).

TABLE 1

| | N | S | X |
|---|---|---|---|
| N | Yes | Yes | Yes |
| S | Yes | Yes | No |
| X | Yes | No | No |

As shown in Table 1, S-locks are compatible with each other while X-locks are exclusive.

Serializable transaction isolation protects not only existing records and key values but also non-existing ones. For example, after a query such as “Select count(*) From T Where T.a=15” has returned a count of zero, the same query within the same transaction must return the same count. In other words, the absence of key value 15 must be locked for the duration of the transaction. Key range locking achieves this with a lock on a neighboring existing key value in a mode that protects not only the existing record but also the gap between two key values.

In at least some examples, the disclosed deadlock resolution engine is compatible with a key range locking protocol that ensures maximal concurrency for serializable transactions. Without limitation to other examples, the disclosed deadlock resolution engine is compatible with the theory of multi-granularity and hierarchical locking to keys and gaps in B-tree leaves. Further, fence keys and ghost (pseudo-deleted) records may be exploited and can be locked as needed.

Fence keys are keys that define the lowest and highest keys that can exist in a node. Fence keys enable efficient key range locking, as well as the inexpensive and continuous, yet comprehensive, verification of the B-tree structure and all its invariants.

Meanwhile, ghost records are a technique used in many B-tree implementations, by which a user transaction that requests a deletion marks the deleted record invalid by flipping a “ghost bit” instead of actually erasing it. Ghost records do not contribute to query results, but the key of a ghost record does participate in concurrency control and key range locking just as the key of a valid record would.

The disclosed deadlock resolution engine is compatible with a locking protocol that provides specific locking instructions for cursors. More specifically, the disclosed deadlock resolution engine is compatible with a deadlock detection mechanism that manages the end points of inclusive and exclusive, ascending and descending cursors.

ARIES/KVL refers to a locking protocol to ensure serializability by locking neighboring keys. In addition to the newly inserted key, it locks the next key until the new key is inserted and locked. Meanwhile, ARIES/IM refers to a locking protocol that reduces the number of locks for tables with multiple secondary indexes. However, in some cases, these designs unnecessarily reduce concurrency, because they do not differentiate locks on keys from locks on ranges between keys.

Various key range lock modes are compatible with the disclosed deadlock resolution engine. For example, a set of key range lock modes implemented in a Microsoft SQL Server may be suitable. In this design, there is a separation between key and range. Further, a lock mode can have two parts—range mode and key mode. The key mode protects an existing key value while the range mode protects the range down to the previous key (aka “next-key locking”). For example, the “RangeX-S” lock protects a range in exclusive mode and a key with share mode. Compatibility of key mode and lock mode is orthogonal. Two locks are compatible if and only if both key modes and both range modes are compatible, respectively.

However, if a key range lock mechanism treats key and range not completely orthogonally, the design is sometimes too conservative. For example, a “RangeS-N” mode may be lacking (where N stands for “not locked”), which would be a useful lock to protect the absence of a key value. Further, a “RangeS-X” mode and/or a “RangeX-N” mode may be lacking. For example, suppose an index on column T.a has keys 10, 20, and 30. One transaction issues “Select * From T Where T.a=15”, which leaves a “RangeSS” lock on key value 20. When another transaction issues “Update T Set b=1, Where T.a=20”, its lock request conflicts with the previous lock although these transactions really lock different things and actually do not violate serializability.

There is another comprehensive and orthogonal set of key range lock modes that enable simplicity as well as concurrency. This set of key range lock modes combines them with fence keys, ghost records, and system transactions, and thus permits a first empirical evaluation and comparison of the design. In at least some examples, the disclosed deadlock resolution engine is compatible with a comprehensive and orthogonal set of key range lock modes.

In a Data-Oriented execution (DORA) approach, physical lock contentions are eliminated by assigning threads for logical partition of data. The approach is analogous to PLP for latching. The tie between execution model and the locking protocol has some assumptions and limitations. Also, the work is orthogonal to concurrency of lock modes because they eliminate only physical lock contentions, not logical contentions (logical concurrency).

Table 2 shows a list of key range lock modes compatible with the disclosed deadlock resolution engine in accordance with examples of the disclosure.

TABLE 2

| | N | S | X | NS | NX | SN | SX | XN | XS |
|---|---|---|---|---|---|---|---|---|---|
| N | Yes | Yes | Yes | Yes | Yes | Yes | Yes | Yes | Yes |
| S | Yes | Yes | No | Yes | No | Yes | No | No | No |
| X | Yes | No | No | No | No | No | No | No | No |
| NS | Yes | Yes | No | Yes | No | Yes | No | Yes | Yes |
| NX | Yes | No | No | No | No | Yes | No | Yes | No |
| SN | Yes | Yes | No | Yes | Yes | Yes | Yes | No | No |
| SX | Yes | No | No | No | No | Yes | No | No | No |
| XN | Yes | No | No | Yes | Yes | No | No | No | No |
| XS | Yes | No | No | Yes | No | No | No | No | No |

In Table 2, the key range lock modes may protect half-open intervals [A,B). For example, ‘SX’ mode (pronounced “key shared, gap exclusive”) protects the key A in shared mode and the open interval (A,B) in exclusive mode. S is a synonym for SS, X for XX.

However, using these locks, locks on key values and gaps are orthogonal. In the example above, the first transaction and its query “Select * From T Where T.a=15” can lock key value 10 (using prior-key locking) in “NS”-mode (key free, gap shared). Another transaction's concurrent “Update T Set b=1 Where T.a=10” can lock the same key value 10 in “XN”-mode (key exclusive, gap free). In some cases, a lock in RangeS-S mode is taken and thus have lower concurrency than the disclosed NS-lock, which allows concurrent updates on neighboring keys because NS and XN are compatible.

When a query searches for a non-existing key that sorts below the lowest key value in a leaf page but above the separator key in the parent page, a “NS”-lock on the low fence key in the leaf is used. Since the low fence key in a leaf page is equal to the high fence key in the next leaf page to the left, key range locking works across leaf page boundaries.

Point queries: Algorithms 1 and 2 show the pseudo code for INSERT and SELECT queries (UPDATE and DELETE are omitted for convenience).

Algorithm 1: INSERT locking protocol

```
Data: B: B-tree index, L: Lock table
Input: key: Inserted key
leaf page = B.Traverse(key); // hold latch*
slot = leaf page.Find(key);
if slot.key == key then //Exact match
    L.Request-Lock(key, XN);
    if slot is not ghost then
        return (Error: DUPLICATE);
        leaf page.Replace-Ghost(key);
else //Non-existent key. In this case, slot is the previous key
    if slot < 0 then //hits left boundary of the page
        L.Check-Lock(leaf page.low fence key, NX);
    else
        L.Check-Lock(slot.key, NX);
    begin System-Transaction
        leaf page.Create-Ghost(key);
    L.Request-Lock(key, XN);//lock the ghost
    leaf page.Replace-Ghost(key);
*To reduce the time latches are held, all lock requests are conditional. If denied, immediately give up and release latches, then lock unconditionally followed by a page LSN check.
```

Algorithm 2: SELECT locking protocol

```
Data: B: B-tree index, L: Lock table
Input: key: Searched key
leaf page = B.Traverse(key); // hold S latch
slot = leaf page.Find(key);
if slot.key == key then //Exact match
    L.Request-Lock(key, SN);
    if slot is not ghost then
        return (slot.data);
    else
        return (Error: NOT-FOUND);
else //Non-existent key
    if slot < 0 then //hits left boundary of the page
        L.Request-Lock(leaf page.low fence key, NS);
    else
        L.Request-Lock(slot.key, NS);
    return (Error: NOT-FOUND);
```

In at least some examples, a locking mechanism may first checks if the corresponding leaf page has the key being searched for. If so, a key-only lock mode such as SN and XN suffices. This is true even if the existing record is a ghost record. Furthermore, the existing ghost record speeds up insertion, which only has to turn it into a non-ghost record (toggling the record's ghost bit and overwriting non-key data).

The design uses system transactions for creating new ghost records as well as all other physical creation and removal operations. User transactions only update existing records, toggling their ghost bits as appropriate. Because a system transaction does not modify the database's logical content, it does not have to take locks, flush its log at the commit time, or undo its effects if the involving user transaction rolls back. This separation greatly simplifies and speeds up internal code paths.

To ensure serializability, traditional designs without fence records sometimes lock key values in neighboring pages. In contrast, by exploiting fence keys are lockable key values, the disclosed design and implementation takes locks only on keys within the current page, simplifying and speeding up the locking protocol.

Range queries such as “Select * From T Where T.a Between 15 And 25” need cursors protected by lock modes as shown in Table 3. The lock mode to take depends on the type of cursors (ascending or descending) and on the inclusion or exclusion of boundary values in the query predicate (e.g., key>15 or key_{—}15). When a cursor initially locates its starting position, it either takes a lock on the existing key (exact match), or the previous key (non-existent) or the low fence key of the page). Then, as it moves to next key or next page, it also takes a lock on the next key (including fence keys).

Because a cursor takes a lock for each key, the overhead to access the lock table is relatively high. This is the reason why the locks marked with (*) in Table 3 are more conservative than necessary. For example, an ascending cursor starting from exact-match on A could take only an “SN” lock on A and then upgrade to an “S” lock on the same key when moving on to the next key. However, this doubles the overhead to access the lock table. Accordingly, in at least some examples, a suitable deadlock detection mechanism may take the two locks at the same time to reduce the overhead at the cost of slightly lower concurrency, which is the same trade-off as the coarse-grained lock herein.

TABLE 3

| Cursor type | |
|---|---|
| Ascending | Descending |

| Boundary type | Incl. | Excl. | Incl. | Excl. |
|---|---|---|---|---|
| Initial (exact match) | S* | NS | SN* | N |
| Initial (non-exact | NS | NS | S | S |
| match) | | | | |
| Initial (non-exact | NS | NS | NS | NS |
| match; fence low) | | | | |

| | | |
|---|---|---|
| Next; page-move | S (SN if last) | S (NS if last) |

Deadlocks can cause major bottlenecks in databases when two or more competing transactions permanently block each other from acquiring locks that they both need in order to succeed. For example, concurrent transactions may acquire locks in an order that causes a cycle in wait-for relationships. Deadlock resolution requires at least one of the transactions causing the deadlock to release locks. This involves either a partial rollback, a lock de-escalation, or most commonly a transaction termination. The throughput of the entire system depends on the efficiency and accuracy of the deadlock detection and resolution algorithms.

Deadlock handling methods in databases may grouped into two categories: deadlock prevention and deadlock resolution. The deadlock prevention approach ensures that the database never enters into a deadlock (e.g., using a timeout policy for intent locks). Meanwhile, the deadlock resolution approach detects deadlocks when they happen and resolves the situation by rolling back some transactions.

The downside of the prevention approach is that prevention algorithms such as wound-wait and wait-die proactively catch a suspicious situation and rollback transactions, which may result in false positives. A timeout algorithm with long waits causes fewer false deadlocks, but delays resolution of the situation. The main drawback of the deadlock resolution approach is its high computational overhead. Constructing a wait-for graph and detecting a cycle in it requires checking all transactions' status and probing the lock queues they are waiting on. This is especially problematic on many-cores due to synchronization between threads. Atomically constructing or maintaining such a global data structure requires a long blocking or a large number of mutex calls for synchronization, which are both unacceptable overheads in a many-core architecture.

Thus, a common practice is to run detection only periodically (e.g., once a minute), but, again, this delays deadlock detection. The performance of each approach was evaluated by simulation. One of the conclusions was that there is no one-size-fits-all solution among them. The best algorithm or its parameter depends on characteristics of transactions that are usually unknown a priori.

In at least some examples, the disclosed deadlock resolution engine is related to a deadlock detection mechanism similar to a Dreadlocks technique (notice the “r”), which is an algorithm specifically designed to help many-core hardware efficiently detect deadlocks. The basic idea of the Dreadlocks algorithm is that each core (thread) recursively collects the identity of cores it depends on (dependency). If the core finds itself in the dependencies, there must be a cycle in the wait-for relationships. A similar idea has been explored in deadlock detection in distributed databases. In order to efficiently collect dependencies on many-core hardware, the Dreadlocks algorithm maintains only a local information store in each core, called a digest, which is asynchronously propagated by the other cores waiting for that core. Such propagation is done as a part of the spinning (waiting).

Illustration 1 and Table 5 illustrate how the Dreadlocks technique works.

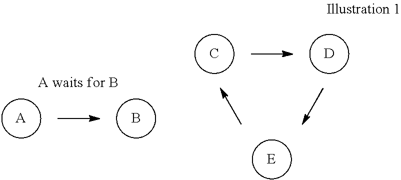

TABLE 5

| | Digests | | | | |
|---|---|---|---|---|---|
| Steps | A | B | C | D | E |
| 1 | {A} | {B} | {C} | {D} | {E} |
| 2 | {A, B} | {B} | {C, D} | {D, E} | {E, C} |
| 3 | {A, B} | {B} | {C, D, E} | {D, E, C} | {E, C, D} |
| 4 | {A, B} | {B} | Deadlock! | Deadlock! | Deadlock! |

Each core starts with only itself in the digest. At the second step, each core checks another core it is waiting for and adds its digest to its own digest, for example A adds B to its digest. At the third step, C, D, and E find more digests in the cores they are waiting for because of the previous propagation. As a consequence, C, D, and E all contain each other in their digests. Hence, at the last step, C finds itself in D's digest, detecting a deadlock. D and E detect deadlocks accordingly. As for A, no deadlock is raised because B's digest does not contain A. The Dreadlocks technique applies to threads as well as locks. In the case of per-lock spins on each lock, the technique works well only when the number of locks is smaller than the number of cores. However, in databases, there are usually many more locks than threads and cores. Hence, per-thread spinning is the more practical choice. The Dreadlocks can use either a bit-vector to fully store the identity or a compact Bloom filter to probabilistically (but without false negatives) detect deadlocks. As the maximum number of concurrent transactions is not known a priori, Bloom filters are more appropriate than bit-vectors. They are also much more efficient to read and compute than other forms of full dependency information.

The Dreadlocks approach is highly scalable, simple, and applicable to many situations. It finds deadlocks very accurately and quickly with low overhead because of its simplicity and local-only spin accesses. However, there are a few issues to be addressed to adapt it for use in database systems—namely, lock modes, queues, and upgrades. First, the original Dreadlocks algorithm assumes that each lock has a single “owner”. Each waiter takes the union of its digest and that of the owner of the lock. In databases, locks have various lock modes such as S, X, and NX. Furthermore, a thread may upgrade an already-granted lock. Suppose a thread A took an SN lock on some key. Another thread B then took an SN lock on the key. The thread A then tries to upgrade the lock to XN mode, becoming a waiter due to B's SN lock (SN and XN are incompatible). Even a granted lock might be also a waiter, thus database locks do not have a good notion of “owner”.

In order to achieve fair scheduling, database lock requests are placed in lock queues which grants locks in the request order. In the above example, if another thread C comes with a request for an SN lock, it must not be granted because of the waiting upgrade request by A. If the lock manager were to grant an SN lock to C (and other subsequent requests), A might starve. Thus, C should wait until B and then A finish and release their locks. Hence, a database lock might have to wait even though all of the granted locks in the queue are compatible with the request.

Algorithm 5 shows operations of a suitable deadlock detection engine, which may by understood to be similar to the Dreadlocks technique with modifications for database operations. Like the original Dreadlocks, each thread repeatedly collects the digest and computes the union of its own fingerprint. The fingerprint of a thread is a randomly and uniquely chosen n bits out of m bits, the size of Bloom filters. For example, if n=3 and m=512, the fingerprint of thread A might be (12,43,213) while that of B might be (43,481,500). In at least some examples, fingerprints per-thread are assigned instead of per-transactions because a transaction might be carried out by multiple threads. In the given example, the initial digest of Transaction A is an array of 512 bits. All bits are OFF except 12th, 43rd, and 213th bits which are ON. When the union of the other digests is taken, bitwise OR is computed.

Unlike the original Dreadlocks algorithm, the disclosed deadlock detection engine iterates over all lock requests in the same lock queue instead of a single owner. Suppose two threads A and B, and their lock requests on the same queue. If B precedes A in the lock queue, B has higher priority and A can be granted only when its requested lock mode is compatible with B's requested (not only granted) lock mode. On the other hand, if A precedes B in the queue, A has priority and A can be granted as far as its requested lock mode is compatible with B's granted lock mode. In either case, if A's lock request cannot be granted because of B, B is said to be A's dependency and B's digest is added to A's digest. Further, if B's digest contains A's fingerprint, it implies a deadlock. Hence, either of the transactions is aborted, depending on the deadlock recovery policy.

In at least some examples, the disclosed deadlock detection engine performs deadlock detection operations like the original Dreadlocks technique. However, databases might have to process more concurrent threads than the number of cores. For example, suppose an ad hoc query comes and there are already as many running threads as the number of cores. If the new query simply waits, its query latency could be severely affected, especially when the query is short and read-only (as often is the case with ad hoc queries). On the other hand, if the query were run immediately, a purely spin-based Dreadlocks would severely damage the overall throughput, greedily wasting CPU resources. This is an even more significant issue because databases have various background threads such as buffer pool cleaners and log flushers. Keeping all CPU cores busy might affect such critical operations.

A simple solution for this problem is to have each thread sleep after each spin. However, this caused frequent false deadlock detections. For example, suppose thread A, B and C update the same resource. Let A currently hold an X lock on the resource. First B and then C request locks on the resource and start waiting; thus their digests contain A. To avoid wasting CPU cycles, B and C fall into a sleep. When A commits and releases locks, A wakes up B who will be granted the lock next. However, C is still asleep. Then, thread A starts another transaction and happens to access the same resource. Because C has not yet refreshed its digest, A finds itself in the digest of C and aborts itself as deadlock. This repeats until C wakes up from the sleep, wasting CPU cycles and lowering system throughput.

However, frequent false deadlocks rapidly reduce throughput as the number of concurrent threads increases, defeating the purpose of the sleep. The problem is that the digest of threads waiting on some lock becomes outdated when its dependency is released. In the pure spinning algorithm, such a digest is quickly refreshed and never causes false deadlocks. However, pure spinning wastes too much CPU cycles. In at least some examples, the disclosed deadlock resolution engine addresses this issue by adding backoff at lock release. For example, whenever a lock is released, a flag is asserted for all threads waiting for the lock which indicates the digest of the thread is outdated. Upon the next spin, such a thread is tentatively ignored from the digest computation to avoid false deadlocks. The flag is de-asserted by the marked thread itself when it wakes up next time and refreshes its digest. Rather than actually waking up all the waiting threads to make them immediately update the digest, this approach minimizes the overhead of lock release (which is the critical path of the highly contended resource).

When a deadlock condition is detected, a transaction is rolled back to release its locks. The deadlock resolution policy affects the entire throughput because an inefficient policy keeps voiding the work each transaction made and might prevent the entire workload from proceeding. Instead of using a policy that selects the most recent transaction to roll back, the disclosed deadlock resolution engine uses the length of the pipeline. This strategy is based on the observation that rolling back the most recent transaction is inefficient in the existence of flush pipelining. When the database is pipelining transactions, the cost of aborting one transaction is not only wasting its own work. To release locks after commit, a transaction has to make sure its log is flushed. Therefore, the aborted pipeline has to flush its logs before releasing its locks. This causes a substantial wait in the pipeline which would be otherwise free from flush waits. If each pipeline is frequently and randomly aborted, the benefit of using flush pipelines is lost. Accordingly, the disclosed deadlock resolution engine considers the length of the pipelines, not the current transaction. When two transactions are in deadlock, the disclosed deadlock resolution engine checks their pipelines and compare the number of completed transactions in each pipeline. The abort shortest pipeline policy employed by the disclosed deadlock resolution engine avoids repeated deadlocks and achieves up to 4× faster throughput than other deadlock resolution policies in test experiments.

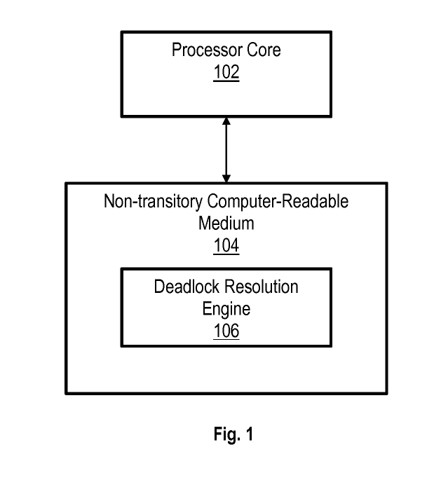

FIG. 1 shows a system 100 in accordance with an example of the disclosure. As shown, the system 100 comprises a processor core 102 in communication with a non-transitory computer-readable medium 104 storing a deadlock resolution engine 106 to resolve a deadlock condition based on an abort shortest pipeline policy.

In at least some examples, the deadlock resolution engine 106 causes the processor core 102 to compare pipelines of two deadlocked transactions and to flush whichever of the pipelines is shorter. Additionally or alternatively, the deadlock resolution engine 106 causes the processor core 102 to compare pipelines of two deadlocked transactions and to flush whichever of the pipelines is estimated to minimize an amount of work to be redone. Additionally or alternatively, the deadlock resolution engine 106 causes the processor core 102 to compare pipelines of two deadlocked transactions and to flush whichever of the pipelines has fewer completed transactions.

In at least some examples, the deadlock resolution engine 106 operates in conjunction with a deadlock detection engine that accounts for set of database lock modes when determining whether the deadlock condition exists. Further, the deadlock detection engine may accounts for upgrades of previously-granted locks when determining whether the deadlock condition exists. Further, the deadlock detection engine may determine whether the deadlock condition exists by iterating over all lock requests in a lock queue without regard to lock request ownership.

In some examples, the non-transitory computer-readable medium 104 storing the deadlock resolution engine 106 is separate from the processor core 102. In alternative examples, the non-transitory computer-readable medium 104 storing the deadlock resolution engine 106 is integrated with the processor core 102. In some examples, transaction pipelines related to operations deadlock resolution engine 106 or pipeline information may be stored in another data storage unit accessible to the processor core 102. Similarly, the transaction pipelines or pipeline information may be stored in the processor core 102 or in the non-transitory computer-readable medium 104.

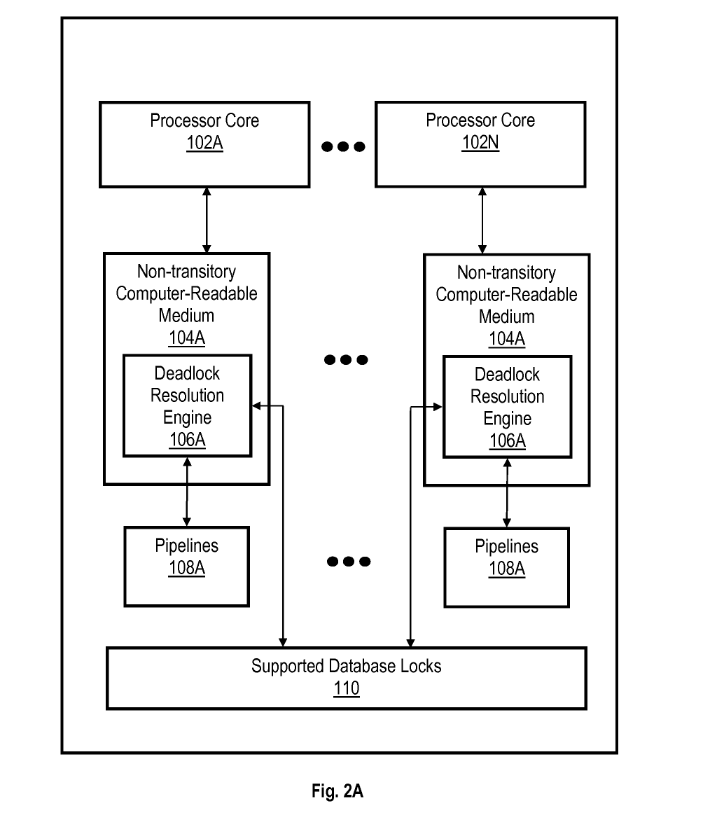

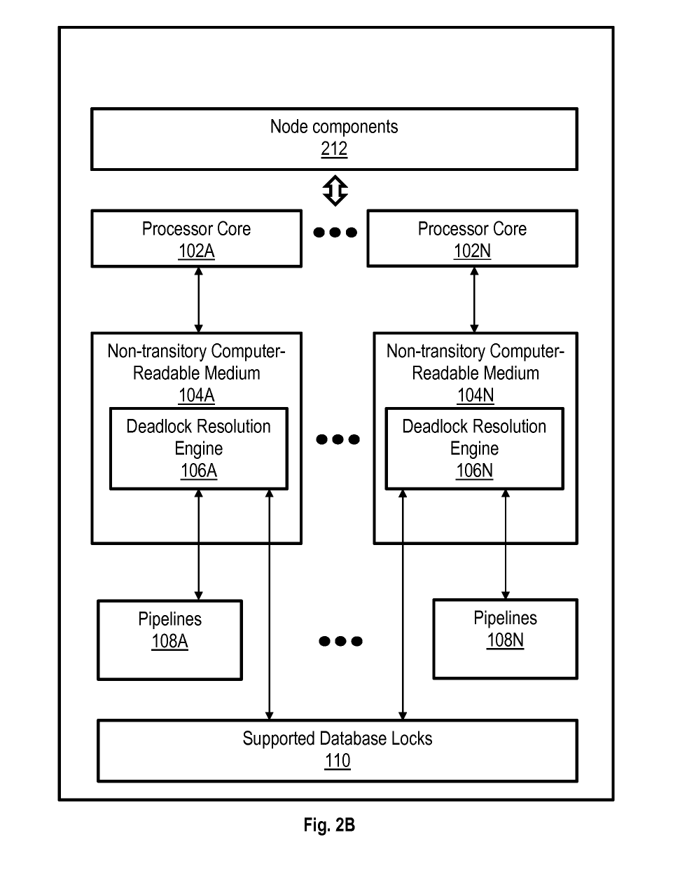

FIG. 2A shows a multi-core processor 200 in accordance with an example of the disclosure. As shown, the multi-core processor 200 may comprise a plurality of processor cores 102A-102N. Each of the processor cores 102A-102N is in communication with a non-transitory computer-readable medium 104A-104N storing a respective deadlock resolution engine 106A-106N. In other words, each of the processor cores 102A-102N may be associated with a respective deadlock resolution engine 106A-106N. Each of the deadlock resolution engines 106A-106N has access to respective pipelines 108A-108N and to a supported database locks module 110. The pipelines 108A-108N and the supported database locks module 110 support the deadlock resolution engine operations as described herein. Further, each of the deadlock resolution engines 106A-106N may perform the various deadlock resolution engine operations described for the deadlock resolution engine 106 of FIG. 1. Without limitation to other examples, the deadlock resolution engines 106A-106N and the pipelines 108A-108N may support a database share mode, an exclusive mode, and/or upgradeable locks as described herein. The supported database locks module 110 may be shared by the deadlock resolution engines 106A-106N, or each of the deadlock resolution engines 106A-106N may have its own supported database locks module 110.

In some examples, the non-transitory computer-readable mediums 104A-104N storing the respective deadlock resolution engines 106A-106N are separate from the respective processor cores 102A-102N. In alternative examples, the non-transitory computer-readable mediums 104A-104N storing the respective deadlock resolution engines 106A-106N are integrated with the respective processor cores 102A-102N. Further, in some examples, the pipelines 108A-108N and/or the supported database locks module 110 may be stored in the respective processor cores 102A-102N or in the respective non-transitory computer-readable mediums 104A-104N. In alternative examples, the pipelines 108A-108N and/or the supported database locks module 110 may be stored in at least one data storage unit accessible to the processor cores 102A-102N. In different examples, the pipelines 108A-108N and/or the supported database locks module 110 may be stored in the multi-core processor 200 or may be external to the multi-core processor 200. Further, in different examples, the deadlock resolution engines 106A-106N for the respective processor cores 102A-102N may be stored in the multi-core processor 200 or may be external to the multi-core processor 200.

FIG. 2B shows a multi-processor node 210 in accordance with an example of the disclosure. As shown, the multi-processor node 210 of FIG. 2B comprises the same or similar components as described for the multi-core processor 200 of FIG. 2A, and the same discussion provided for the multi-core processor components is applicable to the multi-processor node components. Also, the multi-processor node 210 may comprise node components 212 such as memory resources, input/output resources, a communication fabric, a node controller, and/or other components in communication with the processor cores 102A-102N. In different examples, the pipelines 108A-108N and/or the supported database locks module 110 may be stored in the multi-processor node 210 or may be external to the multi-processor node 210. Further, in different examples, the deadlock resolution engines 106A-106N for the respective processor cores 102A-102N may be stored in the multi-processor node 210 or may be external to the multi-processor node 210.

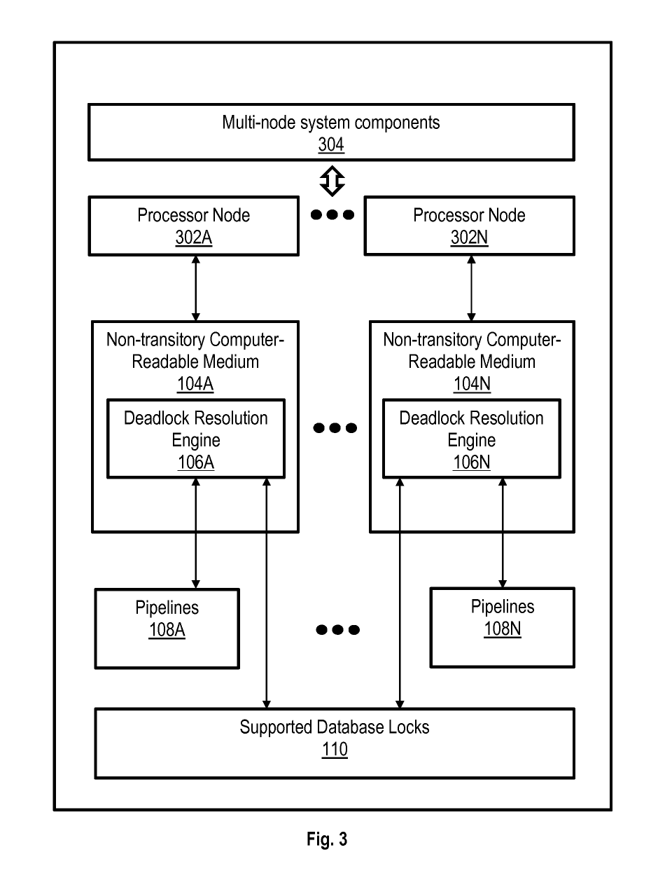

FIG. 3 shows a multi-node system 300 in accordance with an example of the disclosure. As shown, the multi-node system 300 comprises a plurality of processor nodes 302A-302N. Each of the processor nodes 302A-302N may comprise processing resources, memory resources, and I/O resources. Further, the multi-node system 300 may comprise various of the same or similar components as described for the multi-core processor 200 of FIG. 2A, and the same discussion provided for the multi-core processor components is applicable to the multi-node system components. Also, the multi-node system 300 may comprise multi-node system components 304 such as multi-node memory resources, multi-node input/output resources, a multi-node communication fabric, node controllers, and/or other components in communication with the processor nodes 302A-302N. In different examples, the pipelines 108A-108N and/or the supported database locks module 110 may be stored in the multi-node system 300 or may be external to the multi-node system 300. Further, in different examples, the deadlock resolution engines 106A-106N for the respective processor nodes 302A-302N may be stored in the multi-node system 300 or may be external to the multi-node system 300.

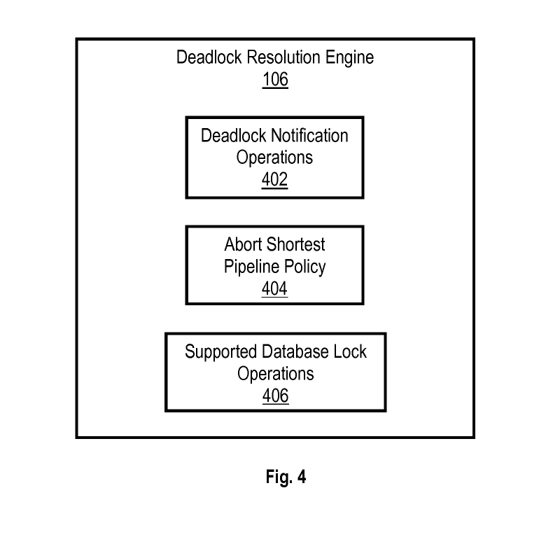

FIG. 4 shows the deadlock resolution engine 106 in accordance with an example of the disclosure. As shown, the deadlock resolution engine 106 comprises deadlock notification operations 402, abort shortest pipeline policy operations 404, and supported database lock operations 406. When executed, the deadlock notification operations 402 enable a processor to receive a deadlock notification as described herein. The deadlock notifications may be based on a deadlock detection engine customized for database lock modes, upgradeable locks, and/or lock modes where ownership is not considered.

Further, the abort shortest pipeline policy operations 404 may perform the deadlock resolution operations described herein by comparing pipelines of two deadlocked transactions and flushing whichever of the pipelines is shorter. Further, the abort shortest pipeline policy operations 404 may perform the deadlock resolution operations described herein by comparing pipelines of two deadlocked transactions and flushing whichever of the pipelines is estimated to minimize an amount of work to be redone. Further, the abort shortest pipeline policy operations 404 may perform the deadlock resolution operations described herein by comparing pipelines of two deadlocked transactions and flushing whichever of the pipelines has fewer completed transactions.

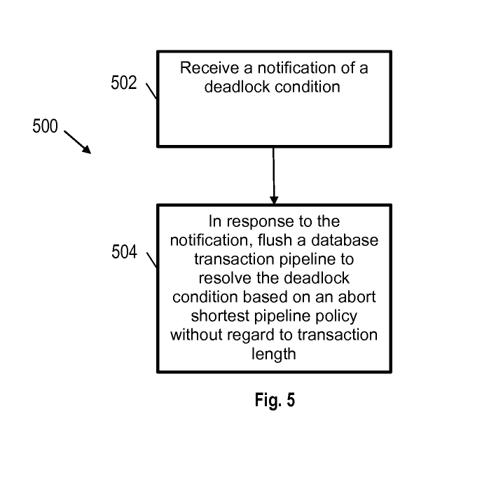

FIG. 5 shows a method 500 in accordance with an example of the disclosure. The method 500 may be performed, for example, by a processor core 102, a processor node 302, or a computer system. As shown, the method 500 comprises receiving a notification of a deadlock condition at block 502. At block 504, the method 500 comprises flushing, in response to the notification, a database transaction pipeline to resolve the deadlock condition based on an abort shortest pipeline policy without regard to transaction length.

The method 500 may additionally or alternatively comprise other steps. For example, the method 500 may comprise comparing pipelines of two deadlocked transactions and flushing whichever of the pipelines is shorter to resolve the deadlock condition. Further, the method 500 may comprise comparing pipelines of two deadlocked transactions and flushing whichever of the pipelines has fewer completed transactions to resolve the deadlock condition. Further, the method 500 may comprise raising the notification of the deadlock condition based on a deadlock detection program that accounts for a set of database lock modes. Further, the method 500 may comprise raising the notification of the deadlock condition based on a deadlock detection program that accounts for upgrades of previously-granted locks. Further, the method 500 may comprise raising the notification of the deadlock condition based on a deadlock detection program that that iterates over all lock requests in a lock queue without regard to lock request ownership.

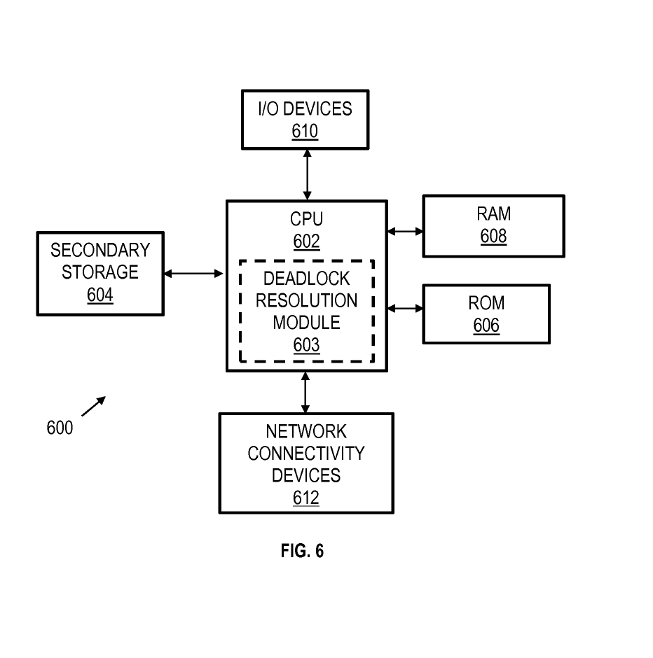

FIG. 6 shows components of a computer system 600 in accordance with an example of the disclosure. The computer system 600 may perform various operations to support the deadlock resolution engine operations described herein. The computer system 600 may correspond to part of database system that includes the processor core 102, the multi-core processor 200A, the multi-processor node 200B, and/or the multi-node system 300 described herein.

As shown, the computer system 600 includes a processor 602 (which may be referred to as a central processor unit or CPU) that is in communication with memory devices including secondary storage 604, read only memory (ROM) 606, random access memory (RAM) 608, input/output (I/O) devices 610, and network connectivity devices 612. The processor 602 may be implemented as one or more CPU chips. As shown, the processor 602 comprises a deadlock resolution module 603, which corresponds to a software implementation of the deadlock resolution engine described herein. Alternatively, the deadlock resolution module 603 may be stored external to the processor 602 and may be accessed as needed to perform the deadlock resolution engine operations described herein. In some examples, the deadlock resolution engine 106 of FIG. 1 may include the processor 602 executing the deadlock resolution module 603.

It is understood that by programming and/or loading executable instructions onto the computer system 600, at least one of the CPU 602, the RAM 608, and the ROM 606 are changed, transforming the computer system 600 in part into a particular machine or apparatus having the novel functionality taught by the present disclosure. In the electrical engineering and software engineering arts that functionality that can be implemented by loading executable software into a computer can be converted to a hardware implementation by well-known design rules. Decisions between implementing a concept in software versus hardware may hinge on considerations of stability of the design and numbers of units to be produced rather than any issues involved in translating from the software domain to the hardware domain. For example, a design that is still subject to frequent change may be implemented in software, because re-spinning a hardware implementation is more expensive than re-spinning a software design. Meanwhile, a design that is stable that will be produced in large volume may be preferred to be implemented in hardware, for example in an application specific integrated circuit (ASIC), because for large production runs the hardware implementation may be less expensive than the software implementation. Thus, a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

The secondary storage 604 is typically comprised of one or more disk drives or tape drives and is used for non-volatile storage of data and as an over-flow data storage device if RAM 608 is not large enough to hold all working data. Secondary storage 604 may be used to store programs which are loaded into RAM 608 when such programs are selected for execution. The ROM 606 is used to store instructions and perhaps data which are read during program execution. ROM 606 is a non-volatile memory device which typically has a small memory capacity relative to the larger memory capacity of secondary storage 604. The RAM 608 is used to store volatile data and perhaps to store instructions. Access to both ROM 606 and RAM 608 is typically faster than to secondary storage 604. The secondary storage 604, the RAM 608, and/or the ROM 606 may be referred to in some contexts as computer readable storage media and/or non-transitory computer readable media.

I/O devices 610 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 612 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. These network connectivity devices 612 may enable the processor 602 to communicate with the Internet or one or more intranets. With such a network connection, it is contemplated that the processor 602 might receive information from the network, or might output information to the network in the course of performing the above-described method steps. Such information, which is often represented as a sequence of instructions to be executed using processor 602, may be received from and outputted to the network, for example, in the form of a computer data signal embodied in a carrier wave.

Such information, which may include data or instructions to be executed using processor 602 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well known to one skilled in the art. The baseband signal and/or signal embedded in the carrier wave may be referred to in some contexts as a transitory signal.

The processor 602 executes instructions, codes, computer programs, scripts which it accesses from hard disk, floppy disk, optical disk (these various disk based systems may all be considered secondary storage 604), ROM 606, RAM 608, or the network connectivity devices 612. While only one processor 602 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 604, for example, hard drives, floppy disks, optical disks, and/or other device, the ROM 606, and/or the RAM 608 may be referred to in some contexts as non-transitory instructions and/or non-transitory information.

In an example, the computer system 600 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an example, virtualization software may be employed by the computer system 600 to provide the functionality of a number of servers that is not directly bound to the number of computers in the computer system 600. For example, virtualization software may provide twenty virtual servers on four physical computers. In an example, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an example, some or all of the deadlock resolution engine functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 600, at least portions of the contents of the computer program product to the secondary storage 604, to the ROM 606, to the RAM 608, and/or to other non-volatile memory and volatile memory of the computer system 600. The processor 602 may process the executable instructions and/or data structures in part by directly accessing the computer program product, for example by reading from a CD-ROM disk inserted into a disk drive peripheral of the computer system 600. Alternatively, the processor 602 may process the executable instructions and/or data structures by remotely accessing the computer program product, for example by downloading the executable instructions and/or data structures from a remote server through the network connectivity devices 612. The computer program product may comprise instructions that promote the loading and/or copying of data, data structures, files, and/or executable instructions to the secondary storage 604, to the ROM 606, to the RAM 608, and/or to other non-volatile memory and volatile memory of the computer system 600.

In some contexts, the secondary storage 604, the ROM 606, and the RAM 608 may be referred to as a non-transitory computer readable medium or a computer readable storage media. A dynamic RAM example of the RAM 608, likewise, may be referred to as a non-transitory computer readable medium in that while the dynamic RAM receives electrical power and is operated in accordance with its design, for example during a period of time during which the computer 600 is turned on and operational, the dynamic RAM stores information that is written to it. Similarly, the processor 602 may comprise an internal RAM, an internal ROM, a cache memory, and/or other internal non-transitory storage blocks, sections, or components that may be referred to in some contexts as non-transitory computer readable media or computer readable storage media.

Such a non-transitory computer-readable storage medium may store a deadlock resolution management program that performs the operations described herein for the deadlock resolution engine 106. For example, the deadlock resolution management program, when executed, may cause the processor 602 to maintain a receive notification of a deadlock condition. In response to the notification, the deadlock resolution management program may cause the processor 602 to resolve the deadlock condition based on an abort shortest pipeline policy without regard to transaction length.

In at least some examples, the deadlock resolution management program, when executed, also may cause the processor 602 to compare pipelines of two deadlocked transactions and to flush whichever of the pipelines is shorter. Further, the deadlock resolution management program, when executed, also may cause the processor 602 to compare pipelines of two deadlocked transactions and to flush whichever of the pipelines is estimated to minimize an amount of work to be redone. Further, the deadlock resolution management program, when executed, also may cause the processor 602 to compare pipelines of two deadlocked transactions and to flush whichever of the pipelines has fewer completed transactions.

In at least some examples, the deadlock resolution management program, when executed, also may cause the processor 602 to assert the deadlock condition based on a deadlock detection program that accounts for set of database lock modes. Further, the deadlock resolution management program, when executed, also may cause the processor 602 to assert the deadlock condition based on deadlock detection program that accounts for upgrades of previously-granted locks. Further, the deadlock resolution management program, when executed, also may cause the processor 602 to assert the deadlock condition based on a deadlock detection program that iterates over all lock requests in a lock queue without regard to lock request ownership.

The above discussion is meant to be illustrative of the principles and various examples of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a processor core; and
a non-transitory computer-readable memory in communication with the processor core and storing a deadlock resolution engine to resolve a deadlock condition based on an abort shortest pipeline policy.

2. The system of claim 1, wherein the deadlock resolution engine causes the processor core to compare pipelines of two deadlocked transactions and to flush whichever of the pipelines is shorter.

3. The system of claim 1, wherein the deadlock resolution engine causes the processor core to compare pipelines of two deadlocked transactions and to flush whichever of the pipelines is estimated to minimize an amount of work to be redone.

4. The system of claim 1, wherein the deadlock resolution engine causes the processor core to compare pipelines of two deadlocked transactions and to flush whichever of the pipelines has fewer completed transactions.

5. The system of claim 1, wherein the deadlock resolution engine operates in conjunction with a deadlock detection engine that accounts for set of database lock modes when determining whether the deadlock condition exists.

6. The system of claim 1, wherein the deadlock resolution engine operates in conjunction with a deadlock detection engine that accounts for upgrades of previously-granted locks when determining whether the deadlock condition exists.

7. The system of claim 1, wherein the deadlock resolution engine operates in conjunction with a deadlock detection engine that determines whether the deadlock condition exists by iterating over all lock requests in a lock queue without regard to lock request ownership.

8. A non-transitory computer-readable medium storing a deadlock resolution management program that, when executed, causes a processor to:
receive notification of a deadlock condition; and
in response to the notification, to resolve the deadlock condition based on an abort shortest pipeline policy without regard to transaction length.

9. The non-transitory computer-readable medium of claim 8, wherein the deadlock resolution management program, when executed, further causes the processor to compare pipelines of two deadlocked transactions and to flush whichever of the pipelines is shorter.

10. The non-transitory computer-readable medium of claim 8, wherein the deadlock resolution management program, when executed, further causes the processor to compare pipelines of two deadlocked transactions and to flush whichever of the pipelines is estimated to minimize an amount of work to be redone.

11. The non-transitory computer-readable medium of claim 8, wherein the deadlock resolution management program, when executed, further causes the processor to compare pipelines of two deadlocked transactions and to flush whichever of the pipelines has fewer completed transactions.

12. The non-transitory computer-readable medium of claim 8, wherein the deadlock resolution management program, when executed, further causes the processor to assert the deadlock condition based on a deadlock detection program that accounts for set of database lock modes.

13. The non-transitory computer-readable medium of claim 8, wherein the deadlock resolution management program, when executed, further causes the processor to assert the deadlock condition based on deadlock detection program that accounts for upgrades of previously-granted locks.

14. The non-transitory computer-readable medium of claim 8, wherein the deadlock resolution management program, when executed, further causes the processor to assert the deadlock condition based on a deadlock detection program that iterates over all lock requests in a lock queue without regard to lock request ownership.

15. A method, comprising:
receiving, by a processor, a notification of a deadlock condition; and
in response to the notification, flushing, by the processor, a database transaction pipeline to resolve the deadlock condition based on an abort shortest pipeline policy without regard to transaction length.

16. The method of claim 15, further comprising comparing pipelines of two deadlocked transactions and flushing whichever of the pipelines is shorter to resolve the deadlock condition.

17. The method of claim 15, further comprising comparing pipelines of two deadlocked transactions and flushing whichever of the pipelines has fewer completed transactions to resolve the deadlock condition.

18. The method of claim 15, further comprising raising the notification of the deadlock condition based on a deadlock detection program that accounts for set of database lock modes.

19. The method of claim 15, further comprising raising the notification of the deadlock condition based on a deadlock detection program that accounts for upgrades of previously-granted locks.

20. The method of claim 15, further comprising raising the notification of the deadlock condition based on a deadlock detection program that that iterates over all lock requests in a lock queue without regard to lock request ownership.
